(19) United States
(12) Patent Application Publication
(10) Pub. No.: US 2011/0122722 A1
(43) Pub. Date: May 26, 2011

(54) FLOATING MIXER AND METHOD

(76) Inventor: Alfons Schmidt, Delbruck (DE)

(21) Appl. No.: 13/056,073

(22) PCT Filed: Jun. 12, 2009
(86) PCT No.: PCT/EP09/57288

§ 371 Date: Jan. 26, 2011

(30) Foreign Application Priority Data
Jul. 30, 2008 (DE) 10 2008 040 850.6

(51) Int. Cl. B01F 15/06; B01F 15/02

(52) U.S. Cl. 366/146; 366/177.1; 366/147; 366/144

(57) ABSTRACT

The invention relates to a mixer for mixing mixing material at high temperatures of for example 300° C. to 600° C., as well as to a method for operating the mixer. It is an object of the invention to provide a mixer that can comprise a plurality of feeding members which are capable of following the movements of the mixer even at high temperatures. For achieving the object, the mixer comprises such installation means that an area of the mixing container is or can be fixed relative to the ground surface, said area can be provided on both sides with feeding members. Because a horizontal mixer can be fixed only at one front face in the case of a mixer according to the prior art, feeding members can only be connected with the mixing container from a side adjacent to the end wall. If, however, a horizontal mixer is configured such that one area, which is located between two front faces of a mixing container, is or can be fixed relative to the ground surface, then feeding members can be connected with the mixing container on both sides of this area. During operation, the mixer is heated to temperatures of at least 300° C.

The invention relates to a mixer for mixing material at high temperatures of for example 300° C. to 600° C. as well as to a method for operating the mixer. It is known from printed publication DE 19800567 A to heat mixing material disposed in a horizontal mixer to a temperature of 500° C. and more.

A mixer comprises a container and one or more shafts with mixing tools attached thereto. Furthermore, the container of a heatable mixer is provided with heating means. A mixer comprising one or more horizontally supported, rotatable shafts and mixing tools attached thereto is a horizontal mixer. As a rule, the container of a mixer has the shape of a right circular cylinder. The shaft extends coaxially relative to the cylinder barrel. The shaft is typically driven with means fastened on an end wall of the mixing container. Bearings for the shaft are regularly connected directly with the end walls of the container. If a mixer comprises only one shaft, this extends, in particular, through the center of the circle of the base areas of a cylindrical container.

If a mixer is operated at high temperatures, it must first be heated for its operation to begin. The increase in temperature causes the mixer to expand. If a mixer is cooled off again, for example for performing maintenance work, the mixer shrinks. The thermal expansion and shrinkage phenomena must be taken into account when installing and operating the mixer in order to avoid damage.

It is known from the state of the art to firmly anchor a heatable mixer at one front face, that is, to fasten the corresponding feet of the mixer with screws in the floor and to provide the mixer with sliding blocks at the opposite front face. If a mixer installed in this way is heated or cooled off, the position of the sliding blocks shifts due to the thermal expansions and shrinkages. The thermal expansions and shrinkages can be compensated in this manner.

It is, however, problematic that a mixer may expand by several centimeters, depending on the size of the mixer and the temperature differences that occur. Accordingly, feeding means connected with the mixer, for example conduits connected with the mixer for filling product or mixing material into the mixer, for example, or for being able to generate an overpressure or a vacuum in the mixer, must be carried along. If thermal expansion and shrinkage phenomena are too great, feeding means such as conduits are basically no longer sufficiently flexible to follow these movements. Sufficiently long metal conduits may be able to follow changes of a few millimeters. However, conduits consisting of metal basically cannot compensate movements of several centimeters. The displacement of sliding blocks supporting a heavy, loaded mixer entails relatively high undesired friction forces.

Because feeding means are capable of following the displacements of the mixing container only in a limited extent, feeding means are disposed adjoining the front face of the container which is fixed relative to the ground surface. No feeding means that are incapable of following the greater displacements of the mixer can be provided adjoining the other front face which is provided with sliding blocks. However, only a small number of feeding means can be provided adjoining a front face of the mixing container due to lack of space.

If a horizontal mixer is externally heated using heating elements, then only the housing of the mixer will expand at first. The shaft of a horizontal mixer heats up with a delay in time and therefore expands relative to the housing with a delay in time. In order to be able to compensate these different expansion behaviors, the shaft of a standard horizontal mixer is fixed only at one front face of the mixer housing, and slidably supported on the other side. A sliding support of a shaft is carried out, for example, using a slide ring seal or a gland seal sealing the transition from the shaft to the housing.

If a shaft is sealed by means of a seal which is not slidable relative to the shaft, then the seal is connected tightly with one end of a bellows. The other end of the bellows is then tightly connected with the housing of the mixer in order to be able to compensate displacements of the shaft relative to the housing of a horizontal mixer. Displacements of the shaft relative to the housing of the mixer of ±10 mm thus become possible. However, if the movements become too large, the use of a bellows becomes too uneconomical. Disadvantageously, a bellows moreover has dead spaces in which mixing material can deposit undesirably. Deposits in the bellows restricts its freedom of movement which puts the further operation in jeopardy.

If a mixer is heated up or cooled off, not only the length of the mixing container changes, but also the diameter. Therefore, a mixing container can only be designed and provided with feeding members and the like in such a manner that a change of the diameter can be followed.

If a mixer is heated by, for example, a heated fluid being conducted through a double shell of the container, its container will as a rule heat up non-uniformly. Undesirably, the container may take the shape of a banana.

Various problem arise at high temperatures when heating by means of a double shell. In that case, heating is done preferably by means of an electric heating system, which, as a rule, is a wraparound heating system.

A mixer comprising a mixing container which is rotatably supported by fixed bearings is apparent from printed publication DE-OS 2813773. Since the mixing container is rotatably supported, it is not fixed relative to the ground surface within the meaning of the invention. Moreover, DE 2813773 does not disclose that the mixing container known therefrom can be or is supposed to be fixed relative to the ground surface. The mixing container known from DE-OS 2813773 comprises only a filler neck. There is thus no possibility of providing an area of the mixing container with feeding members on both sides of a fixed mixing container area within the meaning of the invention. Printed publications DE 195 28 018 A1 and DE 198 00 567 A1 disclose mixers comprising a mixing container, a horizontally supported shaft and mixing tools attached thereto for operation at high temperatures. The mixer known from DE 198 00 567 A1 can be heated up to 500° C. by means of a contact heater.

From printed publication DE-PS 1 146 852, a horizontal mixer is known the mixing container of which is suspended with a chain at one front face. This front face is therefore not fixed relative to the ground surface. What is not known from printed publication DE-PS 1 146 852 is to suspend also the other front face so that it is not fixed relative to the ground surface. If the mixing container known therefrom were heated, the entire mixing container would be displaced relative to the ground surface, except for the other front face, due to thermal expansion.

It is an object of the invention to provide a mixer that can comprise a plurality of feeding members which are capable of following the movements of the mixer even at high temperatures.

The object of the invention is achieved by a mixer having the features of the first claim. Advantageous embodiments become apparent from the dependent claims.

For achieving the object, the mixer comprises such installation and fixing means that an area of the mixing container is or can be fixed relative to the ground surface, said area can be provided on both sides with feeding members. Because a horizontal mixer can be fixed only at one front face in the case of a mixer according to the prior art, feeding members can only be connected with the mixing container from a side adjacent to the end wall. If, however, a horizontal mixer is configured such that one area, which is located between two front faces of a mixing container, is or can be fixed relative to the ground surface, then feeding members can be connected with the mixing container on both sides of this area. The fixed area does not change its position relative to the ground surface. The adjoining areas are displaced only a little relative to the ground surface. Because feeding members which are capable of following only small displacements can now be attached on both sides of the fixed areas in contrast to the state of the art, the number of such feeding members can be increased in comparison with the state of the art, namely doubled, as a rule. It is possible to double the possible feeding members particularly if a middle area of the mixing housing is fixed relative to the ground surface. A middle area is, in particular, a middle third between two front faces of a container of a horizontal mixer.

In order to fix a middle area of the mixing container, the two end faces not fixed, and in particular the two front faces of a horizontal mixer, can be provided with sliding blocks. Preferably, however, the mixer is suspended because the creation of friction forces is avoided which would otherwise occur when sliding blocks are displaced. It can thus be avoided that strong forces act on the fixing. In the state of the art, sliding blocks can be replaced with a suspension for the same reasons, in order to avoid a fixed front face of a heatable horizontal mixer being subjected to forces too large, among other things.

In one embodiment of the invention, the means for fixing a portion or area of the container do not contribute to installing the container, in contrast to the state of the art. The installation means alone bear the weight of the container including the fittings. The means for fixing merely ensure that a container portion is fixed relative to the ground surface.

In order to be able to suspend ends of a mixer in a suitable way, there are in one embodiment of the invention supporting rods at the end faces or front faces, which are rotatably attached with one end to a framework or frame, and with the other end to fastening means of the mixing container. Moreover, in the case of a horizontal mixer, the horizontally extending axes or sleeves about which the supporting rods can be rotated extend perpendicular to the axis of rotation of the shaft of the mixer. The supporting rods suspend the mixing container and at the same time enable a longitudinal expansion of the container without any problems. Moreover, in contrast to a chain suspension, the position of the mixing container is stabilized advantageously, because the rods can swing out laterally only in a limited extent. In this embodiment, the installation means thus comprise a frame or framework, supporting rods as well as fastening means attached to the mixing container.

In order to facilitate adjustment, the supporting rods can be formed by a rod with an external thread and a pipe with an internal thread screwed thereto. Desired lengths of the supporting rods can be set or adjusted by screwing the rod with an external thread in and out. Preferably, the supporting rods are formed by two joint heads with a right-hand and left-hand external thread located in bores and a rod with a right-hand and left-hand internal thread screwed thereto. The desired lengths can then be set by turning the rod with the internal thread in the right-hand or left-hand direction.

For example, plates or rods are attached to two opposite ends of the mixing container, for example, welded on laterally. Ends of the attached plates or rods are rotatably connected with the supporting rods in order thus to suspend the corresponding end of the mixing container.

In order to avoid in an improved manner a rotation of the mixing container about a vertical axis, there are, for example, in one embodiment of the invention horizontally arranged fastening rods disposed parallel to the ground or ground surface. These fastening rods are, for example, connected to front faces of the mixing container and, furthermore, to a frame, for example, on which the mixing container is kept suspended. The configuration and attachment preferably correspond to the configuration and the attachment of the supporting rods. However, the axes or bushings about which the fastening rods can be rotated extend parallel to the mixer shaft in the case of an attachment on the side of the front face.

The invention typically relates to a batch mixer, that is, a discontinuously operated mixer. A batch mixer is filled with mixing material via a charging apparatus attached on one container, said charging apparatus being generally located above the container. The mixed material is generally withdrawn via a discharge means. In one embodiment of the invention, the drive for the shaft of the mixer is separated and installed outside of the container of the mixer. In that case, there is no direct connection between the drive and the container. Thus, there are only indirect connections, primarily limited to a connection through the shaft and via a framework or ground and installation means. This reduces the danger of the drive undesirably overheating together with the container of the mixer and thereby being damaged.

In the same sense, bearings supporting the weight of the shaft are preferably provided separate and outside of the container of the mixer in order thus to prevent the bearings from overheating. In that case, the bearings for the shaft are not attached directly on or in the container. In any case, this embodiment can be realized easily in a case where it is ensured, by an appropriate installation of the mixer, that the shaft does not move upwards, downwards or laterally due to thermal influences.

In order to prevent the shaft from being displaced in space due to a change of the diameter and an externally installed drive and external bearings from having to follow this displacement, the mixing container in one embodiment of the invention is attached at the level of the shaft, in particular suspended at the level of the shaft. If the diameter of the mixing container changes, this does not cause a displacement in space of the shaft. It is not necessary in this embodiment that a drive provided outside of the mixing container or bearings for the shaft provided outside of the mixing container have to be readjusted due to thermal influences. The shaft is guided through the mixing container such that the shaft can be displaced along its axis without having to displace the mixing container at the same time, so that an externally disposed drive for the shaft does not have to compensate a change in length of the shaft due to temperature changes.

The shaft is only sealed against the mixing container. Only the end of the shaft which is connected with the drive is kept fixed relative to the ground surface. If “the shaft” is referred to, this is not to preclude that the mixer has several shafts with mixing tools attached thereto. Preferably, however, the invention relates to a mixer with only one shaft.

Preferably, the bearings for a shaft and/or a drive for a shaft can be adjusted in particular in the vertical direction in one embodiment, in order to be able to react in any case to temperature changes and changes connected therewith.

In one embodiment of the invention, the shaft is displaceably held by a bearing on one side, and in particular only on one side, the bearing being located outside of the container and not being attached directly on the container. The bearing can be a ball bearing. A section of the shaft held by this bearing can be pushed through the bearing. Because the shaft is held displaceably in a bearing—for example in a loose bearing—the shaft can expand or shrink without any problem.

In order to avoid the undesirable generation of a banana shape because of areas of varying temperature, an electric heating system is used in one embodiment of the invention which can heat different areas of the container shell differently in a controlled manner. By heating in a suitably varying manner, the undesired creation of a banana-shaped container housing can be successfully counteracted. Therefore, if, for example, a banana shape threatens to occur, for example because cold mixing material is filled into a heated mixer and because, accordingly, the underside of the container cools off locally, the underside is relatively intensively heated in order to prevent the container housing from cooling off on one side and thus, the occurrence of a banana shape. It is therefore possible, by providing independently heatable zones, to counteract differences in temperature and thus, prevent the container from distorting.

In the mixer according to the invention, it is readily possible, despite the large differences in temperature occurring in the mixer, to arrange a charging apparatus at a distance from the end wall of a horizontal mixer. If charging is done at a front face of a mixer, the shaft with the mixing tools must be started up very soon in order to transport the mixing material away from the front face. If it is possible to fill in the mixing material from the front face, this problem becomes smaller because more space is available for forming a material cone.

If gases or vapors generated during mixing are withdrawn, a relatively large calming zone in the form of a tube with a large diameter must be provided through which the vapors and gases created are withdrawn. Due to present invention it becomes possible to accommodate such a calming zone comparatively easily, even if it is capable of following only small displacements.

In order to avoid sealing problems during removal, a removal opening is preferably provided in the section of the container which is fixed close to the ground surface.

The charging means for the mixer comprises in particular a vacuum connection or a connection whereby an overpressure can be generated in the container. The charging means is preferably provided in the section of the container which is fixed relative to the ground surface.

Secondary devices are in that case located next to the charging assembly. Liquid feeds, special feeds, manholes etc. are preferably provided laterally of the section of the container which is fixed relative to the ground surface. Liquid feeds can be provided with long conduits and they can thus better follow displacements. Manholes serve the purpose of being able to get into the interior of the mixer for maintenance purposes, for example. If small parts are to be added by hand, there are appropriate special connections which also pose few problems.

In order to avoid temperatures that are too high in the seals and bearings of the shaft, the shaft is cooled from the inside in one embodiment of the invention. For this purpose, the shaft comprises, for example, an interior bore, preferably up to the seal sealing the transition to the container. The bore is flushed externally with cooling agents in order thus to cool the area of the shaft up to the seal. A trouble-free operation is thus ensured in an improved manner. If the bore extends only up to the seal, then only that area is cooled which should be expediently kept cool. The area in the mixer then participates actively in the mixing process with its own temperature.

In one embodiment, the mixer differs from the prior art in that there is a supporting frame, framework or a frame on which the mixer is suspended in a floating manner.

The parts of the mixer, such as installation means, fixing means, bearings, shaft, container, drive and/or mixing tools consist preferably completely or for the most part of steel.

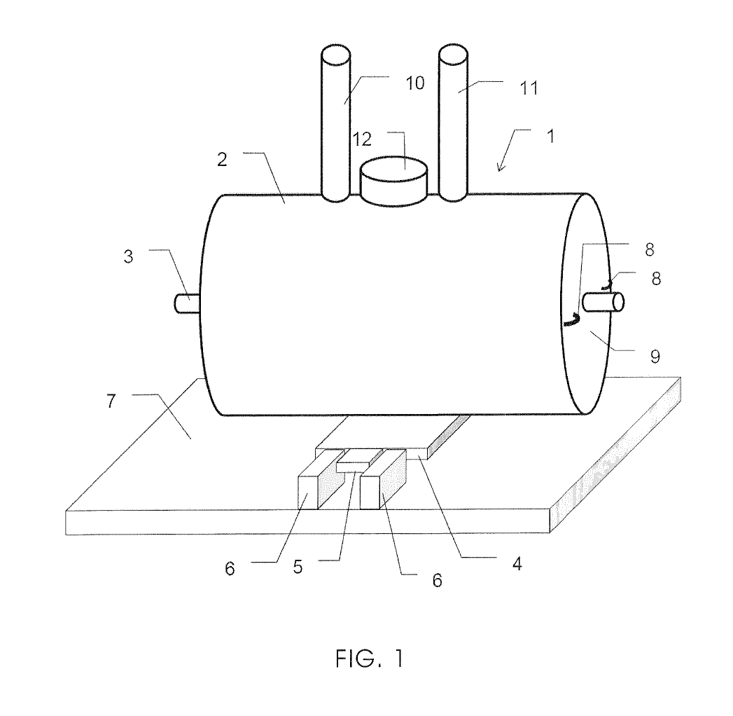

FIG. 1 outlines a horizontal mixer 1 with a circular-cylindrical container 2. A shaft 3, to which mixing tools are attached inside the container, extends through the center of the two front faces. A guiding means 4, which is provided with one protruding end 5, respectively, on each of the two sides, is attached on the underside of the mixing container 2 in the middle between the two front faces. Each protruding end 5 is located between two guiding jaws 6. The guiding jaws 6 are attached to the ground surface 7 and cannot be displaced relative to the ground surface 7. The container is fixed relative to the ground surface within the meaning of the invention by the guiding means and the guiding jaws. Thus, guiding means including the protruding ends as well as the guiding jaws are fixing means within the meaning of the invention.

A total of four fastening means 8 or means for suspending are attached at the level of the shaft 3 laterally next to the shaft on the two front faces of the mixing container. The mixing container is suspended on these four fastening means and thus floatingly supported.

The center of the mixing container between the two front faces cannot be displaced parallel relative to the ground surface because the guiding jaws 6 prevent a parallel displacement of the protruding ends 5. Thus, if the container 3 is, for example, heated up, the suspended front faces 9 are displaced relative to the ground surface, but not the middle section or area above the guiding means 4. This area can now be used to attach feeding means 10, 11, 12 to the container which are only able to follow parallel displacements of the container 2 to a small extent.

Because the container 2 is suspended, its diameter can change without any problems due to changes in temperature. For example, if the container is heated up, its diameter can expand without any problems. On the one hand, this is accomplished by the suspension, and on the other hand, by the protruding ends 5 being able to move downwards.

Since the fastening means 8 are attached at the level of the shaft, a change in the diameter of the container does not cause the position in space of the shaft 3 to change. The fixing means 4, 5 and 6 preventing a parallel displacement also contributes to the stabilization of the position in space of the shaft 3.

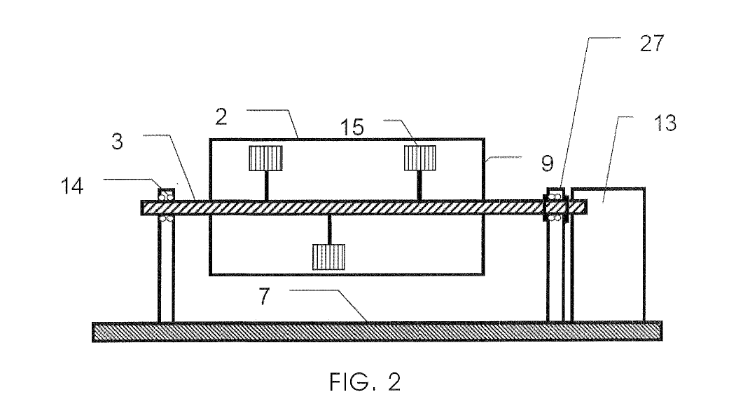

Since the shaft does not change its position due to changes of the diameter of the container, the shaft 3 is connected with a drive 13 outlined in section in FIG. 2 in one embodiment of the invention, said drive being non-displaceable relative to the ground surface and located outside of the container 2 and installed separate from it. The drive 13 comprises a bearing, or a bearing 27 is disposed adjacent, with which the shaft is retained, preferably in such a way that the shaft cannot be displaced relative to the bearing 27 along the shaft axis. The bearing 27 is also separate from the container and installed outside of the container in order to prevent the bearing from overheating. The shaft is retained by a second bearing 14 on the opposite side outside of the container and separate from the container. The shaft can be displaced along the shaft axis relative to this bearing. The transitions between the end walls 9 and the shaft 3 are only sealed. Thus, the shaft can be displaced along its axis relative to the end walls. FIG. 2 moreover outlines mixing tools 15 attached to the shaft.

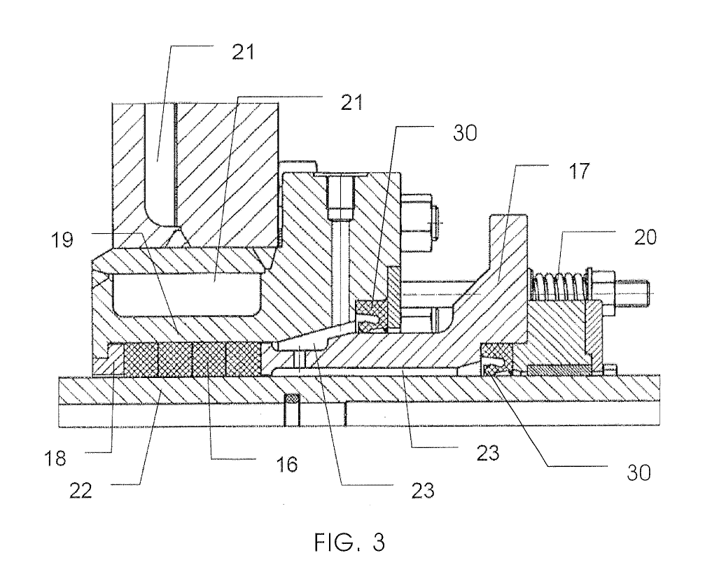

FIG. 3 illustrates in a section the structure of a seal for a shaft 3 opposite the end wall of a container of a horizontal mixer. Sealing is effected by means of packing members 16, for example by a total of four packing members in accordance with the embodiment shown in FIG. 3. A packing member 16 in one embodiment consists of a cord with a square cross section which is filled with graphite material, for example. Such a cord is laid annularly around the shaft or around a sleeve 22 pushed over the shaft. If worn out, a sleeve 22 can be replaced comparatively cheaply and should therefore be preferably provided in the area of the seal and/or the bearings. The ends of the packing members 16 are disposed offset relative to the ends of an adjacent packing member 16. The packing members 16 thus arranged are pressed against one another by a displaceable component 17 which presses the packing members 16 against an abutment 18. The packing members try to draw aside and are thus pressed on the one side against the shaft or sleeve 22 and on the other side against a boundary 19 of the end wall. The displaceable component 17 is resiliently pushed against the packing members 16 with a biased spring 20 in order to maintain the contact pressure. This assembly is suitable only for sealing the shaft against the end wall. The shaft cannot be supported by the seal without damaging the seal, due to a weight that is too great.

One or preferably several annular cavities 21 that can be cooled using cooling agents are disposed around the packing elements in an annular fashion. The seal is thus cooled in order to make a long operating life possible. Several cavities are to be preferred for assembly and fabrication reasons.

In front of the packing elements 16, as seen from the outside, there are one or more cavities 23 which are pressurized with a gas, in particular with nitrogen, so that there is an overpressure in the cavities. Since the displaceable component 17 is sealed towards the outside by means of shaft sealing rings 30 the gas or nitrogen is basically only able to flow through between the packings 16 and the shaft sleeve 22. The gas or nitrogen on the one hand serve as a barrier medium and, on the other hand, as an indicator in case a leak occurs. If more gas or nitrogen than usual is consumed from time to time, this signals that the packings or packing members have to be tightened or replaced.

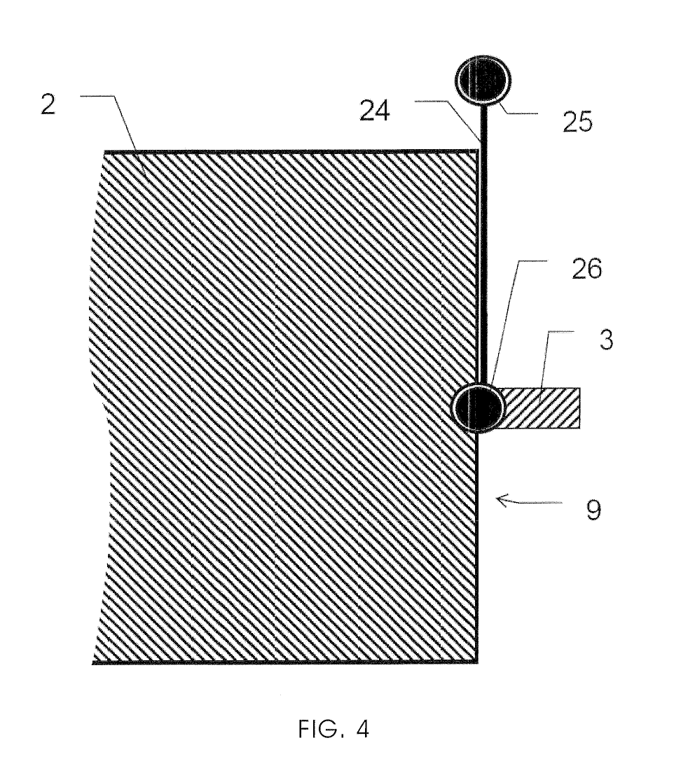

FIG. 4 shows a supporting rod 24 which is rotatably connected to a bolt 25 of a framework or frame and on the other side with a bolt 26 which is welded onto the end wall 9 of a horizontal mixer at the level of the shaft 3. In one embodiment of the invention, a horizontal mixer is floatingly supported by four such supporting rods. The axes or bolts 25, 26 about which a supporting rod 25 can be rotated extend perpendicular relative to the axis of rotation of the shaft 3.

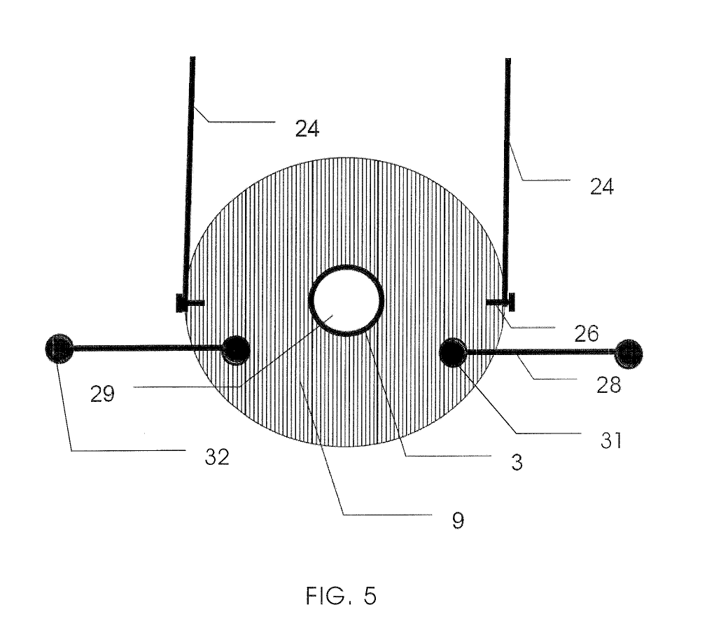

FIG. 5 illustrates the provision of horizontally disposed fastening rods 28 by means of which a rotation of the mixing container about a vertical axis is prevented. The fastening rods 28 shown are rotatably connected with a front face 9 and rotatably connected with, for example, a framework or frame. The axes or bolts 31, 32 about which a horizontally disposed fastening rod 28 can be rotated extend parallel relative to the axis of rotation of the shaft 3.

Seen from the mixer, the supporting rods 24 can constructionally extend downwardly or upwardly un order to suspend or hook in the mixer.

### Floating Mixer and Method

The invention relates to a mixer for mixing material at high temperatures of for example 300° C. to 600° C. as well as to a method for operating the mixer. It is known from printed publication DE 19800567 A to heat mixing material disposed in a horizontal mixer to a temperature of 500° C. and more.

A mixer comprises a container and one or more shafts with mixing tools attached thereto. Furthermore, the container of a heatable mixer is provided with heating means. A mixer comprising one or more horizontally supported, rotatable shafts and mixing tools attached thereto is a horizontal mixer. As a rule, the container of a mixer has the shape of a right circular cylinder. The shaft extends coaxially relative to the cylinder barrel. The shaft is typically driven with means fastened on an end wall of the mixing container. Bearings for the shaft are regularly connected directly with the end walls of the container. If a mixer comprises only one shaft, this extends, in particular, through the center of the circle of the base areas of a cylindrical container.

If a mixer is operated at high temperatures, it must first be heated for its operation to begin. The increase in temperature causes the mixer to expand. If a mixer is cooled off again, for example for performing maintenance work, the mixer shrinks. The thermal expansion and shrinkage phenomena must be taken into account when installing and operating the mixer in order to avoid damage.

It is known from the state of the art to firmly anchor a heatable mixer at one front face, that is, to fasten the corresponding feet of the mixer with screws in the floor and to provide the mixer with sliding blocks at the opposite front face. If a mixer installed in this way is heated or cooled off, the position of the sliding blocks shifts due to the thermal expansions and shrinkages. The thermal expansions and shrinkages can be compensated in this manner.

It is, however, problematic that a mixer may expand by several centimeters, depending on the size of the mixer and the temperature differences that occur. Accordingly, feeding means connected with the mixer, for example conduits connected with the mixer for filling product or mixing material into the mixer, for example, or for being able to generate an overpressure or a vacuum in the mixer, must be carried along. If thermal expansion and shrinkage phenomena are too great, feeding means such as conduits are basically no longer sufficiently flexible to follow these movements. Sufficiently long metal conduits may be able to follow changes of a few millimeters. However, conduits consisting of metal basically cannot compensate movements of several centimeters. The displacement of sliding blocks supporting a heavy, loaded mixer entails relatively high undesired friction forces.

Because feeding means are capable of following the displacements of the mixing container only in a limited extent, feeding means are disposed adjoining the front face of the container which is fixed relative to the ground surface. No feeding means that are incapable of following the greater displacements of the mixer can be provided adjoining the other front face which is provided with sliding blocks. However, only a small number of feeding means can be provided adjoining a front face of the mixing container due to lack of space.

If a horizontal mixer is externally heated using heating elements, then only the housing of the mixer will expand at first. The shaft of a horizontal mixer heats up with a delay in time and therefore expands relative to the housing with a delay in time. In order to be able to compensate these different expansion behaviors, the shaft of a standard horizontal mixer is fixed only at one front face of the mixer housing, and slidably supported on the other side. A sliding support of a shaft is carried out, for example, using a slide ring seal or a gland seal sealing the transition from the shaft to the housing.

If a shaft is sealed by means of a seal which is not slidable relative to the shaft, then the seal is connected tightly with one end of a bellows. The other end of the bellows is then tightly connected with the housing of the mixer in order to be able to compensate displacements of the shaft relative to the housing of a horizontal mixer. Displacements of the shaft relative to the housing of the mixer of ±10 mm thus become possible. However, if the movements become too large, the use of a bellows becomes too uneconomical. Disadvantageously, a bellows moreover has dead spaces in which mixing material can deposit undesirably. Deposits in the bellows restricts its freedom of movement which puts the further operation in jeopardy.

If a mixer is heated up or cooled off, not only the length of the mixing container changes, but also the diameter. Therefore, a mixing container can only be designed and provided with feeding members and the like in such a manner that a change of the diameter can be followed.

If a mixer is heated by, for example, a heated fluid being conducted through a double shell of the container, its container will as a rule heat up non-uniformly. Undesirably, the container may take the shape of a banana.

Various problem arise at high temperatures when heating by means of a double shell. In that case, heating is done preferably by means of an electric heating system, which, as a rule, is a wraparound heating system.

A mixer comprising a mixing container which is rotatably supported by fixed bearings is apparent from printed publication DE-OS 2813773. Since the mixing container is rotatably supported, it is not fixed relative to the ground surface within the meaning of the invention. Moreover, DE 2813773 does not disclose that the mixing container known therefrom can be or is supposed to be fixed relative to the ground surface. The mixing container known from DE-OS 2813773 comprises only a filler neck. There is thus no possibility of providing an area of the mixing container with feeding members on both sides of a fixed mixing container area within the meaning of the invention.

Printed publications DE 195 28 018 A1 and DE 198 00 567 A1 disclose mixers comprising a mixing container, a horizontally supported shaft and mixing tools attached thereto for operation at high temperatures. The mixer known from DE 198 00 567 A1 can be heated up to 500° C. by means of a contact heater.

From printed publication DE-PS 1 146 852, a horizontal mixer is known the mixing container of which is suspended with a chain at one front face. This front face is therefore not fixed relative to the ground surface. What is not known from printed publication DE-PS 1 146 852 is to suspend also the other front face so that it is not fixed relative to the ground surface. If the mixing container known therefrom were heated, the entire mixing container would be displaced relative to the ground surface, except for the other front face, due to thermal expansion.

It is an object of the invention to provide a mixer that can comprise a plurality of feeding members which are capable of following the movements of the mixer even at high temperatures.

The object of the invention is achieved by a mixer having the features of the first claim. Advantageous embodiments become apparent from the dependent claims.

For achieving the object, the mixer comprises such installation and fixing means that an area of the mixing container is or can be fixed relative to the ground surface, said area can be provided on both sides with feeding members. Because a horizontal mixer can be fixed only at one front face in the case of a mixer according to the prior art, feeding members can only be connected with the mixing container from a side adjacent to the end wall. If, however, a horizontal mixer is configured such that one area, which is located between two front faces of a mixing container, is or can be fixed relative to the ground surface, then feeding members can be connected with the mixing container on both sides of this area. The fixed area does not change its position relative to the ground surface. The adjoining areas are displaced only a little relative to the ground surface. Because feeding members which are capable of following only small displacements can now be attached on both sides of the fixed areas in contrast to the state of the art, the number of such feeding members can be increased in comparison with the state of the art, namely doubled, as a rule. It is possible to double the possible feeding members particularly if a middle area of the mixing housing is fixed relative to the ground surface. A middle area is, in particular, a middle third between two front faces of a container of a horizontal mixer.

In order to fix a middle area of the mixing container, the two end faces not fixed, and in particular the two front faces of a horizontal mixer, can be provided with sliding blocks. Preferably, however, the mixer is suspended because the creation of friction forces is avoided which would otherwise occur when sliding blocks are displaced. It can thus be avoided that strong forces act on the fixing. In the state of the art, sliding blocks can be replaced with a suspension for the same reasons, in order to avoid a fixed front face of a heatable horizontal mixer being subjected to forces too large, among other things.

In one embodiment of the invention, the means for fixing a portion or area of the container do not contribute to installing the container, in contrast to the state of the art. The installation means alone bear the weight of the container including the fittings. The means for fixing merely ensure that a container portion is fixed relative to the ground surface.

In order to be able to suspend ends of a mixer in a suitable way, there are in one embodiment of the invention supporting rods at the end faces or front faces, which are rotatably attached with one end to a framework or frame, and with the other end to fastening means of the mixing container. Moreover, in the case of a horizontal mixer, the horizontally extending axes or sleeves about which the supporting rods can be rotated extend perpendicular to the axis of rotation of the shaft of the mixer. The supporting rods suspend the mixing container and at the same time enable a longitudinal expansion of the container without any problems. Moreover, in contrast to a chain suspension, the position of the mixing container is stabilized advantageously, because the rods can swing out laterally only in a limited extent. In this embodiment, the installation means thus comprise a frame or framework, supporting rods as well as fastening means attached to the mixing container.

In order to facilitate adjustment, the supporting rods can be formed by a rod with an external thread and a pipe with an internal thread screwed thereto. Desired lengths of the supporting rods can be set or adjusted by screwing the rod with an external thread in and out. Preferably, the supporting rods are formed by two joint heads with a right-hand and left-hand external thread located in bores and a rod with a right-hand and left-hand internal thread screwed thereto. The desired lengths can then be set by turning the rod with the internal thread in the right-hand or left-hand direction.

For example, plates or rods are attached to two opposite ends of the mixing container, for example, welded on laterally. Ends of the attached plates or rods are rotatably connected with the supporting rods in order thus to suspend the corresponding end of the mixing container.

In order to avoid in an improved manner a rotation of the mixing container about a vertical axis, there are, for example, in one embodiment of the invention horizontally arranged fastening rods disposed parallel to the ground or ground surface. These fastening rods are, for example, connected to front faces of the mixing container and, furthermore, to a frame, for example, on which the mixing container is kept suspended. The configuration and attachment preferably correspond to the configuration and the attachment of the supporting rods. However, the axes or bushings about which the fastening rods can be rotated extend parallel to the mixer shaft in the case of an attachment on the side of the front face.

The invention typically relates to a batch mixer, that is, a discontinuously operated mixer. A batch mixer is filled with mixing material via a charging apparatus attached on one container, said charging apparatus being generally located above the container. The mixed material is generally withdrawn via a discharge means. In one embodiment of the invention, the drive for the shaft of the mixer is separated and installed outside of the container of the mixer. In that case, there is no direct connection between the drive and the container. Thus, there are only indirect connections, primarily limited to a connection through the shaft and via a framework or ground and installation means. This reduces the danger of the drive undesirably overheating together with the container of the mixer and thereby being damaged.

In the same sense, bearings supporting the weight of the shaft are preferably provided separate and outside of the container of the mixer in order thus to prevent the bearings from overheating. In that case, the bearings for the shaft are not attached directly on or in the container. In any case, this embodiment can be realized easily in a case where it is ensured, by an appropriate installation of the mixer, that the shaft does not move upwards, downwards or laterally due to thermal influences.

In order to prevent the shaft from being displaced in space due to a change of the diameter and an externally installed drive and external bearings from having to follow this displacement, the mixing container in one embodiment of the invention is attached at the level of the shaft, in particular suspended at the level of the shaft. If the diameter of the mixing container changes, this does not cause a displacement in space of the shaft. It is not necessary in this embodiment that a drive provided outside of the mixing container or bearings for the shaft provided outside of the mixing container have to be readjusted due to thermal influences. The shaft is guided through the mixing container such that the shaft can be displaced along its axis without having to displace the mixing container at the same time, so that an externally disposed drive for the shaft does not have to compensate a change in length of the shaft due to temperature changes.

The shaft is only sealed against the mixing container. Only the end of the shaft which is connected with the drive is kept fixed relative to the ground surface. If “the shaft” is referred to, this is not to preclude that the mixer has several shafts with mixing tools attached thereto. Preferably, however, the invention relates to a mixer with only one shaft.

Preferably, the bearings for a shaft and/or a drive for a shaft can be adjusted in particular in the vertical direction in one embodiment, in order to be able to react in any case to temperature changes and changes connected therewith.

In one embodiment of the invention, the shaft is displaceably held by a bearing on one side, and in particular only on one side, the bearing being located outside of the container and not being attached directly on the container. The bearing can be a ball bearing. A section of the shaft held by this bearing can be pushed through the bearing. Because the shaft is held displaceably in a bearing—for example in a loose bearing—the shaft can expand or shrink without any problem.

In order to avoid the undesirable generation of a banana shape because of areas of varying temperature, an electric heating system is used in one embodiment of the invention which can heat different areas of the container shell differently in a controlled manner. By heating in a suitably varying manner, the undesired creation of a banana-shaped container housing can be successfully counteracted. Therefore, if, for example, a banana shape threatens to occur, for example because cold mixing material is filled into a heated mixer and because, accordingly, the underside of the container cools off locally, the underside is relatively intensively heated in order to prevent the container housing from cooling off on one side and thus, the occurrence of a banana shape. It is therefore possible, by providing independently heatable zones, to counteract differences in temperature and thus, prevent the container from distorting.

In the mixer according to the invention, it is readily possible, despite the large differences in temperature occurring in the mixer, to arrange a charging apparatus at a distance from the end wall of a horizontal mixer. If charging is done at a front face of a mixer, the shaft with the mixing tools must be started up very soon in order to transport the mixing material away from the front face. If it is possible to fill in the mixing material from the front face, this problem becomes smaller because more space is available for forming a material cone.

If gases or vapors generated during mixing are withdrawn, a relatively large calming zone in the form of a tube with a large diameter must be provided through which the vapors and gases created are withdrawn. Due to present invention it becomes possible to accommodate such a calming zone comparatively easily, even if it is capable of following only small displacements.

In order to avoid sealing problems during removal, a removal opening is preferably provided in the section of the container which is fixed close to the ground surface.

The charging means for the mixer comprises in particular a vacuum connection or a connection whereby an overpressure can be generated in the container. The charging means is preferably provided in the section of the container which is fixed relative to the ground surface.

Secondary devices are in that case located next to the charging assembly. Liquid feeds, special feeds, manholes etc. are preferably provided laterally of the section of the container which is fixed relative to the ground surface. Liquid feeds can be provided with long conduits and they can thus better follow displacements. Manholes serve the purpose of being able to get into the interior of the mixer for maintenance purposes, for example. If small parts are to be added by hand, there are appropriate special connections which also pose few problems.

In order to avoid temperatures that are too high in the seals and bearings of the shaft, the shaft is cooled from the inside in one embodiment of the invention. For this purpose, the shaft comprises, for example, an interior bore, preferably up to the seal sealing the transition to the container. The bore is flushed externally with cooling agents in order thus to cool the area of the shaft up to the seal. A trouble-free operation is thus ensured in an improved manner. If the bore extends only up to the seal, then only that area is cooled which should be expediently kept cool. The area in the mixer then participates actively in the mixing process with its own temperature.

In one embodiment, the mixer differs from the prior art in that there is a supporting frame, framework or a frame on which the mixer is suspended in a floating manner.

The parts of the mixer, such as installation means, fixing means, bearings, shaft, container, drive and/or mixing tools consist preferably completely or for the most part of steel.

FIG. 1 outlines a horizontal mixer 1 with a circular-cylindrical container 2. A shaft 3, to which mixing tools are attached inside the container, extends through the center of the two front faces. A guiding means 4, which is provided with one protruding end 5, respectively, on each of the two sides, is attached on the underside of the mixing container 2 in the middle between the two front faces. Each protruding end 5 is located between two guiding jaws 6. The guiding jaws 6 are attached to the ground surface 7 and cannot be displaced relative to the ground surface 7. The container is fixed relative to the ground surface within the meaning of the invention by the guiding means and the guiding jaws. Thus, guiding means including the protruding ends as well as the guiding jaws are fixing means within the meaning of the invention.

A total of four fastening means 8 or means for suspending are attached at the level of the shaft 3 laterally next to the shaft on the two front faces of the mixing container. The mixing container is suspended on these four fastening means and thus floatingly supported.

The center of the mixing container between the two front faces cannot be displaced parallel relative to the ground surface because the guiding jaws 6 prevent a parallel displacement of the protruding ends 5. Thus, if the container 3 is, for example, heated up, the suspended front faces 9 are displaced relative to the ground surface, but not the middle section or area above the guiding means 4. This area can now be used to attach feeding means 10, 11, 12 to the container which are only able to follow parallel displacements of the container 2 to a small extent.

Because the container 2 is suspended, its diameter can change without any problems due to changes in temperature. For example, if the container is heated up, its diameter can expand without any problems. On the one hand, this is accomplished by the suspension, and on the other hand, by the protruding ends 5 being able to move downwards.

Since the fastening means 8 are attached at the level of the shaft, a change in the diameter of the container does not cause the position in space of the shaft 3 to change. The fixing means 4, 5 and 6 preventing a parallel displacement also contributes to the stabilization of the position in space of the shaft 3.

Since the shaft does not change its position due to changes of the diameter of the container, the shaft 3 is connected with a drive 13 outlined in section in FIG. 2 in one embodiment of the invention, said drive being non-displaceable relative to the ground surface and located outside of the container 2 and installed separate from it. The drive 13 comprises a bearing, or a bearing 27 is disposed adjacent, with which the shaft is retained, preferably in such a way that the shaft cannot be displaced relative to the bearing 27 along the shaft axis. The bearing 27 is also separate from the container and installed outside of the container in order to prevent the bearing from overheating. The shaft is retained by a second bearing 14 on the opposite side outside of the container and separate from the container. The shaft can be displaced along the shaft axis relative to this bearing. The transitions between the end walls 9 and the shaft 3 are only sealed. Thus, the shaft can be displaced along its axis relative to the end walls. FIG. 2 moreover outlines mixing tools 15 attached to the shaft.

FIG. 3 illustrates in a section the structure of a seal for a shaft 3 opposite the end wall of a container of a horizontal mixer. Sealing is effected by means of packing members 16, for example by a total of four packing members in accordance with the embodiment shown in FIG. 3. A packing member 16 in one embodiment consists of a cord with a square cross section which is filled with graphite material, for example. Such a cord is laid annularly around the shaft or around a sleeve 22 pushed over the shaft. If worn out, a sleeve 22 can be replaced comparatively cheaply and should therefore be preferably provided in the area of the seal and/or the bearings. The ends of the packing members 16 are disposed offset relative to the ends of an adjacent packing member 16. The packing members 16 thus arranged are pressed against one another by a displaceable component 17 which presses the packing members 16 against an abutment 18. The packing members try to draw aside and are thus pressed on the one side against the shaft or sleeve 22 and on the other side against a boundary 19 of the end wall. The displaceable component 17 is resiliently pushed against the packing members 16 with a biased spring 20 in order to maintain the contact pressure. This assembly is suitable only for sealing the shaft against the end wall. The shaft cannot be supported by the seal without damaging the seal, due to a weight that is too great.

One or preferably several annular cavities 21 that can be cooled using cooling agents are disposed around the packing elements in an annular fashion. The seal is thus cooled in order to make a long operating life possible. Several cavities are to be preferred for assembly and fabrication reasons.

In front of the packing elements 16, as seen from the outside, there are one or more cavities 23 which are pressurized with a gas, in particular with nitrogen, so that there is an overpressure in the cavities. Since the displaceable component 17 is sealed towards the outside by means of shaft sealing rings 30 the gas or nitrogen is basically only able to flow through between the packings 16 and the shaft sleeve 22. The gas or nitrogen on the one hand serve as a barrier medium and, on the other hand, as an indicator in case a leak occurs. If more gas or nitrogen than usual is consumed from time to time, this signals that the packings or packing members have to be tightened or replaced.

FIG. 4 shows a supporting rod 24 which is rotatably connected to a bolt 25 of a framework or frame and on the other side with a bolt 26 which is welded onto the end wall 9 of a horizontal mixer at the level of the shaft 3. In one embodiment of the invention, a horizontal mixer is floatingly supported by four such supporting rods. The axes or bolts 25, 26 about which a supporting rod 25 can be rotated extend perpendicular relative to the axis of rotation of the shaft 3.

FIG. 5 illustrates the provision of horizontally disposed fastening rods 28 by means of which a rotation of the mixing container about a vertical axis is prevented. The fastening rods 28 shown are rotatably connected with a front face 9 and rotatably connected with, for example, a framework or frame. The axes or bolts 31, 32 about which a horizontally disposed fastening rod 28 can be rotated extend parallel relative to the axis of rotation of the shaft 3.

Seen from the mixer, the supporting rods 24 can constructionally extend downwardly or upwardly un order to suspend or hook in the mixer.

1. Mixer, comprising means for installing and fixing the mixer, characterized in that the means for installing and fixing are configured such that an area of the mixing container is fixed or fixable relative to the ground surface and can be provided on both sides with feeding means.

2. Mixer according to claim 1, wherein a middle area of the mixing container, in particular, a middle third between two front faces of a container of a horizontal mixer, is fixed or fixable.

3. Mixer, in particular according to claim 1, characterized in that the two front faces of the mixing container of a horizontal mixer are held by a suspension such that the front faces are not fixed relative to the ground surface.

4. Mixer according to claim 1, characterized in that the mixer is suspended by four supporting rods that are rotatably connected with the mixing container and rotatably connected with a frame or framework.

5. Mixer according to claim 1, characterized in that the mixer is a horizontal mixer and that its container is suspended at the front faces of the mixing container.

6. Mixer according to claim 1, characterized in that the mixing container is hooked in on supporting rods that comprise a rod with an external thread and a tube or rod with an internal thread.

7. Mixer according to claim 1, characterized in that the mixing container comprises means for suspending the container which are provided at the level of the horizontally supported shaft.

8. Mixer according to claim 1, characterized in that substantially horizontally disposed fastening rods which are disposed at least substantially parallel relative to the ground or ground surface are rotatably connected with the container of the mixer.

9. Mixer according to claim 1, characterized in that the mixer is a batch mixer.

10. Mixer according to claim 1, characterized in that the drive for the shaft of the mixer and/or bearings for supporting the shaft of the mixer are disposed outside of the container and separate from the container.

11. Mixer according to claim 1, characterized in that the shaft of the mixer is displaceable relative to the container of the mixer.

12. Mixer according to claim 1, characterized in that the shaft of the mixer is retained displaceably by means of a bearing.

13. Mixer according to claim 1, characterized in that the mixer is provided with heating means, namely in particular with an electric heating system comprising zones that can be heated independently from one another.

14. Mixer according to claim 1, characterized in that the shaft of the mixer comprises cooling means, namely in particular in the form of at least one bore at least one, preferably at each end of the shaft.

15. Mixer according to claim 1, characterized in that a seal is provided which seals the shaft of the mixer against the housing of the container.

16. Mixer according to claim 15, characterized in that cooling devices for the seal are provided.

17. Mixer according to claim 1, comprising at least one horizontally supported shaft and mixing tools attached thereto.

18. Mixer according to claim 1, comprising guiding jaws and a guiding means guided therein for fixing a section relative to the ground surface.

19. Mixer according to claim 1, comprising a framework or frame for suspending the container of the mixer.

20. Mixer according to claim 1, characterized in that cavities filled with nitrogen are provided so that the nitrogen serves as a barrier medium for the interior.

21. Method for operating a mixer according to claim 1 which is heated up to at least 300° C.
